(19) United States
(12) Patent Application Publication
(10) Pub. No.: US 2020/0128189 A1
(43) Pub. Date: Apr. 23, 2020

(54) CAMERA SYSTEM, CONTROL METHOD AND NON-TRANSITORY COMPUTER-READABLE STORAGE MEDIUM

(71) Applicant: CANON KABUSHIKI KAISHA, Tokyo (JP)

(72) Inventor: Takashi Sugai, Saitama-shi (JP)

(21) Appl. No.: 16/599,515

(22) Filed: Oct. 11, 2019

(30) Foreign Application Priority Data
Oct. 22, 2018 (JP) 2018-198709

(51) Int. Cl. H04N 5/232; H04N 13/239; H04N 13/128; G06T 7/593

(52) U.S. Cl. CPC H04N 5/23299; G06T 7/593; H04N 13/128; H04N 13/239

(57) ABSTRACT

A camera system is provided. The system comprises a first camera fixed to a stage; a second camera which is disposed on a panhead fixed to the stage in a state in which a direction of an optical axis of the second camera is adjustable and which has a narrower field angle than the first camera; a storage unit in which a correlation between a positional coordinate in an image captured by the first camera and an angle of the panhead for directing the optical axis in a direction corresponding to a position of the positional coordinate is stored; and a control unit. The control unit controls the angle of the panhead based on the correlation such that the optical axis is directed to a position corresponding to a positional coordinate of a subject detected from an image captured by the first camera.

### BACKGROUND OF THE INVENTION

### Field of the Invention

The present invention relates to a camera system, a control method thereof, and a non-transitory computer-readable storage medium.

### Description of the Related Art

In a surveillance camera or the like, it is known to combine two cameras, a wide-angle camera and a telephoto camera, detect a subject from a wide-area image obtained by the wide-angle camera, and obtain a detailed image of the subject by the telephoto camera. Japanese Patent Laid-Open No. 2004-364212 describes a physical object capturing apparatus including a wide-angle camera and a telephoto camera using a zoom lens. In the physical object capturing apparatus of Japanese Patent Laid-Open No. 2004-364212, first, an approximate position and size of a subject are calculated by parallel stereopsis of a wide-angle camera and a telephoto camera set at the same field angle as the wide-angle camera. Next, a detailed image is obtained by controlling the electric panhead on which the telephoto camera is mounted and a zoom lens of the camera in accordance with the calculated position and size of the subject.

### SUMMARY OF THE INVENTION

In the configuration of Japanese Patent Laid-Open No. 2004-364212, since position information such as the position and size of a subject is calculated, and settings such as the field angle and the direction of a telephoto camera are determined based on this position information, a long time may be required to obtain a detailed image of the subject.

Some embodiments of the present invention provide a technique that is advantageous at obtaining detailed images of a subject in a shorter time.

According to some embodiments, a camera system, comprising: a first camera fixed to a stage; a second camera which is disposed on a support base of a panhead fixed to the stage in a state in which a direction of an optical axis of the second camera is adjustable and which has a narrower field angle than the first camera; a storage unit in which a correlation between a positional coordinate in an image captured by the first camera and an angle of the support base for directing the optical axis in a direction corresponding to a respective position of the positional coordinate is stored in advance; and a control unit, wherein the control unit controls the angle of the support base based on the correlation such that the optical axis is directed to a position corresponding to a positional coordinate of a subject detected from an image captured by the first camera, is provided.

According to some other embodiments, a control method of a camera system that comprises a first camera fixed to a stage; a second camera which is disposed on a support base of a panhead fixed to the stage in a state in which a direction of an optical axis of the second camera is adjustable and which has a narrower field angle than the first camera; and a storage unit in which a correlation between a positional coordinate in an image captured by the first camera and an angle of the support base for directing the optical axis in a direction corresponding to a respective position of the positional coordinate is stored in advance, the method comprising: detecting a subject from an image captured by the first camera, and controlling the angle of the support base based on the correlation such that the optical axis is directed to a position corresponding to a positional coordinate of a subject detected from an image captured by the first camera, is provided.

According to still other embodiments, a non-transitory computer-readable storage medium storing a program for causing a computer to execute the control method of a camera system that comprises a first camera fixed to a stage; a second camera which is disposed on a support base of a panhead fixed to the stage in a state in which a direction of an optical axis of the second camera is adjustable and which has a narrower field angle than the first camera; and a storage unit in which a correlation between a positional coordinate in an image captured by the first camera and an angle of the support base for directing the optical axis in a direction corresponding to a respective position of the positional coordinate is stored in advance, the method comprising: detecting a subject from an image captured by the first camera, and controlling the angle of the support base based on the correlation such that the optical axis is directed to a position corresponding to a positional coordinate of a subject detected from an image captured by the first camera, is provided.

Further features of the present invention will become apparent from the following description of exemplary embodiments (with reference to the attached drawings).

### BRIEF DESCRIPTION OF THE DRAWINGS

FIG. 1 is a view illustrating an example of a configuration of a camera system according to an embodiment of the present invention.

FIG. 2 is a view for explaining a correlation between coordinate positions of the cameras of the camera system of FIG. 1 and angles of a support base of the panhead.

FIGS. 3A to 3C are views for explaining a method for measuring distances of the camera system of FIG. 1.

FIG. 4 is a view illustrating an effect of lens distortion in a camera system of a comparative example.

FIG. 5 is a view for describing a correction of an effect of lens distortion in the camera system of FIG. 1.

### DESCRIPTION OF THE EMBODIMENTS

Hereinafter, specific embodiments of a camera system according to the present invention will be described with reference to the accompanying drawings. In the following description and the drawings, the same reference numerals denote the same components throughout the plurality of drawings. Therefore, a common configuration will be described with reference to a plurality of drawings, and a description of a configuration to which a common symbol is assigned will be omitted as appropriate.

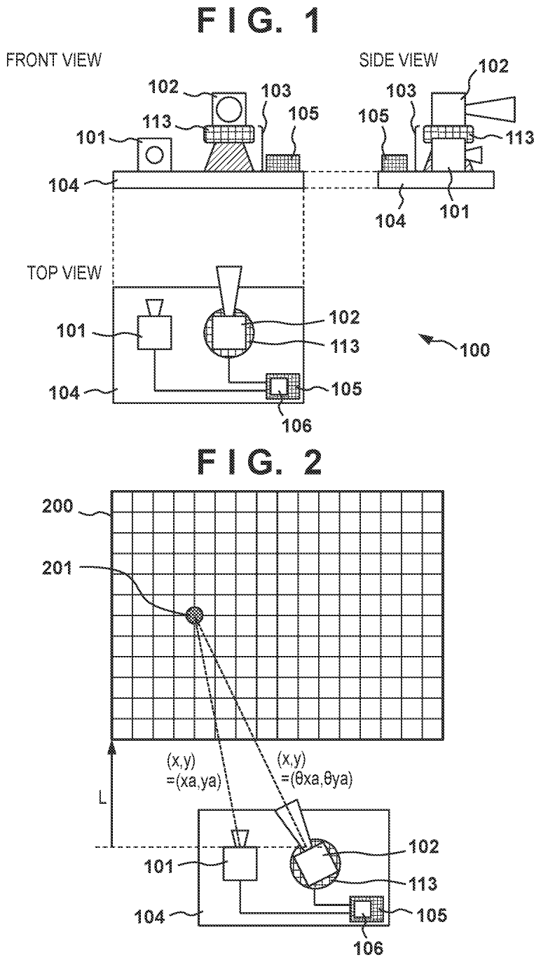

The configuration and operation of a camera system according to embodiments of the present invention will be described with reference to FIGS. 1 to 5. FIG. 1 is a view illustrating a configuration example of a camera system 100 according to an embodiment of the present invention, and illustrates a front view, a side view, and a top view.

The camera system 100 includes two cameras: a camera 101 (first camera) and a camera 102 (second camera). The camera 101 is fixed to a stage 104. In other words, the direction of the optical axis of the camera 101 is fixed. The camera 102 is disposed on a support base 113 of a panhead 103 fixed to the stage 104 in a state in which the direction of the optical axis is adjustable. The direction of the optical axis of the camera 102 can be adjusted in a pan direction and a tilt direction, for example. The camera 102 has a smaller field angle than the camera 101. For this reason, the camera 101 may be referred to as a wide-angle camera, and the camera 102 may be referred to as a telephoto camera. It can also be said that the camera 102 has a longer focal length than the camera 101. It can also be said that the camera 102 has a higher magnification ratio than the camera 101.

The camera system 100 further includes a storage unit 106 and a control unit 105. The control unit 105 includes, for example, one or more programmable processors (such as a CPU and an MPU), and realizes various functions of the camera system 100 by reading and executing programs stored in the storage unit 106. In addition, the storage unit 106 stores in advance a correlation between a positional coordinate in an image captured by the camera 101 and an angle of the support base 113 of the panhead 103 for directing the optical axis of the camera 102 in a direction corresponding to each position of the positional coordinate in the image captured by the camera 101. The control unit 105 controls an angle of the support base 113 of the panhead 103 based on the above-described correlation so that the optical axis of the camera 102 is directed to a position corresponding to a positional coordinate of the subject detected from the image captured by the camera 101. In the configuration illustrated in FIG. 1, the storage unit 106 is illustrated as being incorporated in the control unit 105, but the present invention is not limited thereto. The storage unit 106 and the control unit 105 may have independent configurations.

A wide range is captured by the camera 101, the support base 113 of the panhead 103 is controlled in the pan direction and the tilt direction, and the optical axis of the camera 102 is directed toward the subject. This makes it possible to capture a detailed image of the subject. FIG. 1 illustrates a case in which the planes on which an image is formed for the camera 101 and the camera 102 are arranged on the same plane and the camera 101 and the camera 102 are oriented toward the same target direction. In the side view of FIG. 1, the camera 101 and the camera 102 have different heights from the stage 104, but they are not limited thereto, and may be arranged at the same height, for example. The camera 102 may be variably controlled not only in the pan direction and tilt direction but also in the height direction (height from the stage 104) on the panhead 103.

Next, description will be given of a method for obtaining, in advance, a correlation between positional coordinates in an image captured by the camera 101 and angles of the support base 113 of the panhead 103 for directing the optical axis of the camera 102 in a direction corresponding to each position of the positional coordinates in the image captured by the camera 101. In FIG. 2, a case where the correlation is obtained by arranging a grid-like chart pattern 200 at a position distant from the camera system 100 by a predetermined distance L will be described.

First, the grid-like chart pattern 200, which is at a known distance L from the camera system 100, is captured using the camera 101. The control unit 105 stores in the storage unit 106 positional coordinates of each of a plurality of feature points such as intersection points of the grid in an image captured by the camera 101. For example, the control unit 105 stores in the storage unit 106 the feature point 201 at a position (x, y) on the chart pattern 200 in an image captured by the camera 101 as the positional coordinates (xa, ya) of the feature point 201 in the image captured by the camera 101. Next, the control unit 105 controls the support base 113 of the panhead 103 so that the feature point 201 of the chart pattern 200 is disposed at the center of the image captured by the camera 102. The control unit 105 stores, in the storage unit 106, the angles (θxa, θya) of the support base 113 of the panhead 103 when the feature point 201 at the position (x, y) is disposed at the center of the image captured by the camera 102. At this time, the control unit 105 stores angles (θxa, θya) in the storage unit 106 as angles corresponding to the positional coordinates (xa, ya) of the image captured by the camera 101. The control unit 105 stores, in the storage unit 106, a correlation between the positional coordinates in the image captured by the camera 101 and the angles of the support base 113 when the corresponding feature point is disposed at the center of the image captured by the camera 102, with respect to the plurality of feature points. At this time, by obtaining the correlation at a larger number of feature points, the control unit 105 can control the direction of the optical axis of the camera 102 with higher accuracy and obtain a detailed image.

As described above, the storage unit 106 may store a correlation in advance as a table in which the positional coordinates of the image captured by the camera 101 and the angles of the support base 113 for directing the optical axis of the camera 102 are associated. The control unit 105 immediately controls the angles of the support base 113 of the panhead 103 so that the optical axis of the camera 102 is directed to a position corresponding to the positional coordinates of a detected subject by referring to the table with respect to the subject which is detected from an image captured by the camera 101. Since the correlation is stored in advance, it is possible to shorten the time from the detection of the subject to the obtainment of the detailed image by the camera 102.

Further, for example, the storage unit 106 may separately store the positional coordinates (xa, ya) of an image captured by the camera 101 and the angles (θxa, θya) of the support base for directing the optical axis of the camera 102 with respect to the position (x, y) of the above-described feature point 201. The control unit 105 obtains the position (x, y) from the positional coordinates (xa, ya) of the subject detected from the image captured by the camera 101, and by further obtaining the angles (θxa, θya) of the support base 113 corresponding to the position (x, y), controls the support base 113. Even in this case, the processing amount in the control unit 105 is less than that of the processing for calculating the position and size of the subject described in Japanese Patent Laid-Open No. 2004-364212. Specifically, since the correlation is stored in advance, it is possible to shorten the time from the detection of the subject to the obtainment of the detailed image by the camera 102.

In the present embodiment, it is described that the correlation is based on the image of the grid-like chart pattern arranged at a known distance from the camera system 100 captured by the camera 101 and the camera 102, limitation is not made thereto. The correlation between the positional coordinates in the image obtained by the camera 101 and the angles of the support base 113 of the panhead 103 for directing the optical axis of the camera 102 to a position corresponding thereto may be obtained by any method as long as the correlation is stored in the storage unit 106 in advance.

In addition, the correlation may be obtained from feature points of the chart pattern 200 after arranging the chart pattern 200 at a plurality distances from the camera system 100. For example, when the subject is a known target object, the control unit 105 obtains an approximated distance to the subject in accordance with the size of the subject in the image captured by the camera 101. The control unit 105 can adjust the direction of the optical axis of the camera 102 with high accuracy and obtain a detailed image by controlling the angles of the support base 113 of the panhead 103 based on a correlation according to the approximated distance.

Further, in the present embodiment, since the optical axis of the camera 102 is controlled by using a correlation between the positional coordinates of an image obtained by the camera 101 and the angles of the support base 113 of the panhead 103, a camera having a single focus lens can be used as the camera 102. Therefore, the resolution of the obtained detailed image can be improved as compared with the configuration of Japanese Patent Laid-Open No. 2004-364212 which uses a zoom lens which can be disadvantageous in resolution compared with a single focus lens. In addition, since a configuration for changing the field angle of the zoom lens is not required, the configuration of the entire camera system 100 can be simplified. For example, since no configuration for changing the field angle of the zoom lens itself or mechanical configuration for changing the field angle of the zoom lens provided in the camera system is necessary, problems arising due to such configurations do not occur, and the reliability of the camera system can be improved.

On the other hand, a zoom lens may be used as a lens used for the camera 102. For example, the user may appropriately adjust the field angle of the camera 102 in accordance with the location where the camera system 100 is installed. The camera system 100 may have a configuration in which the field angle of the zoom lens of the camera 102 can be adjusted in accordance with, for example, the size of a subject detected from an image captured by the camera 101. As a result, it is possible to cope with subjects of various sizes. Even when a zoom lens is used as the camera 102, the direction of the optical axis of the camera 102 is controlled by using the correlation between the positional coordinates of the image obtained by the camera 101 and the angles of the support base 113 of the panhead 103. Therefore, after detecting the subject, the camera 102 can be immediately directed to the subject without calculating the direction of the optical axis of the camera 102.

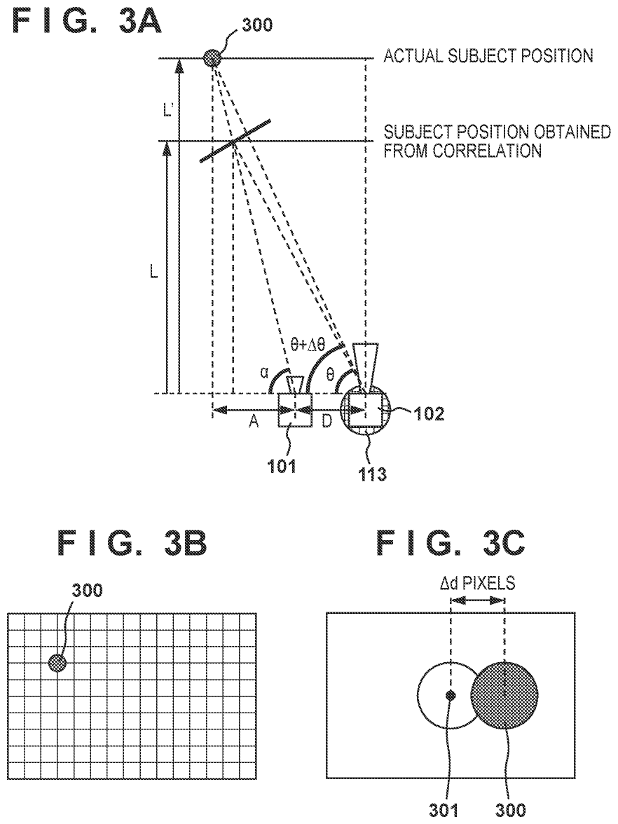

In a surveillance camera or the like using the camera system 100 of the present embodiment, the distance to the subject may be measured. The methods of measuring the distance between the camera system 100 and the subject 300 will be described with reference to FIGS. 3A to 3C.

First, the control unit 105 refers to the correlation for the distance L, and moves the support base 113 of the panhead 103 to the angles corresponding to the positional coordinates of the subject 300 in an image captured by the camera 101 illustrated in FIG. 3B. Next, the control unit 105 obtains a detailed image of the subject captured by the camera 102 illustrated in FIG. 3C. At this time, as illustrated in FIG. 3A, since the subject 300 is not positioned at the distance L but at the distance L′, the actual position of the subject 300 deviates from the position of the subject 300 obtained from the correlation with respect to the direction of the optical axis of the camera 102. For example, as illustrated in FIG. 3C, in the image captured by the camera 102, the subject 300 and the center 301 of the image are shifted by Δd pixels. The control unit 105 calculates an angle error (Δθ) of the support base 113 for directing the optical axis of the camera 102 to the subject 300 from the amount of deviation (Δd pixels) between the subject 300 and the center 301 of the image in the image captured by the camera 102. The control unit 105 obtains the distance L′ to the subject 300 from the intersection of the straight line connecting the camera 101 and the subject 300 and the optical axis of the camera 102 when the support base 113 is moved by the angle (θ+Δθ) so that the subject 300 comes to the center in the image captured by the camera 102. The control unit 105 may calculate the distance L′ to the subject 300 using the following Equations (1) and (2).

L′=(A+D)tan(θ+Δθ) (1)

L′=A tan α (2)

Here, D is a (known) distance between the camera 101 and the camera 102, and α is a (known) angle between the camera 101 and the feature point obtained when the above-mentioned feature point is captured from the camera 101.

In this manner, the control unit 105 obtains the distance from the camera system 100 to the subject 300 based on the positional coordinates of the subject 300 detected from the image captured by the camera 101, the amount of deviation between the subject 300 and the center of the image in the image captured by the camera 102, and the angle of the support base 113 of the panhead 103. The measurement of the distance between the camera system 100 and the subject 300 is not limited to this. For example, first, the control unit 105 moves the optical axis direction of the camera 102 to an angle corresponding to the positional coordinates of the subject 300 detected from the image captured by the camera 101 by controlling the support base 113 of the panhead 103. Next, the control unit 105 further controls the panhead 103 so that the subject 300 is disposed at the center of the image captured by the camera 102. At this time, the control unit 105 may obtain the distance from the camera system 100 to the subject 300 based on the positional coordinates of the subject 300 detected from an image captured by the camera 101 and the angle of the support base 113 of the panhead 103 when the subject 300 is disposed at the center of an image captured by the camera 102.

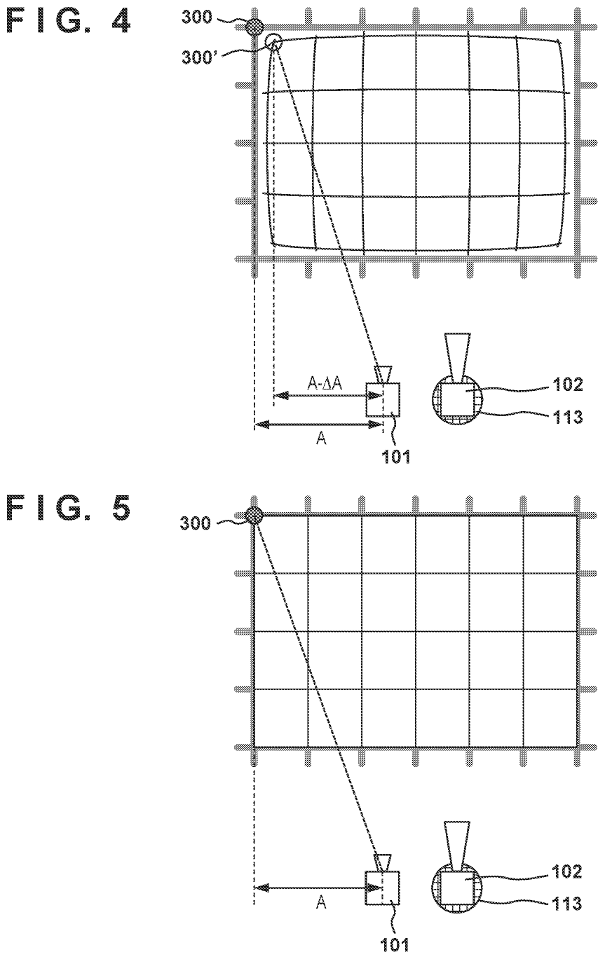

Further, in the present embodiment, since the direction of the optical axis of the camera 102 is controlled by using a correlation between the positional coordinates of an image obtained in advance by the camera 101 and the angle of the support base 113 of the panhead 103, the influence of distortion of a lens in the camera 101 can be reduced. A case where the distance to the subject 300 is measured without using the above-described correlation will be briefly described with reference to FIG. 4. In a camera using a so-called wide-angle lens having a wide field angle as with the camera 101, as illustrated in FIG. 4, an image may be largely distorted in a peripheral portion. If the distortion of the lens is not taken into consideration, as illustrated in FIG. 4, the position of the subject 300′ in the image will deviate from the actual position of the subject 300. The subject 300′ in the image obtained by the camera 101 includes, for example, an error ΔA with respect to the value A used in the process of measuring the distance. This error ΔA reduces the accuracy of the measurement of the distance between the camera system 100 and the subject 300. Further, for example, when the field angle of the camera 102 is small, there is a possibility that the subject 300 will not appear in the image obtained by the camera 102 because of the error ΔA.

On the other hand, in the present embodiment, since the correlation is obtained based on a feature point whose spatial information is known in advance, the distortion component of the image included in the image of the camera 101 can be corrected as illustrated in FIG. 5. Therefore, even when a wide-angle lens having a large distortion is used, the distance between the camera system 100 and the subject 300 can be measured with high accuracy even with respect to the subject 300 positioned at the periphery of the image of the camera 101.

As described above, by controlling the optical axis of the camera 102 using the correlation between the positional coordinates of the image obtained in advance by the camera 101 and the angles of the support base 113 of the panhead 103, it is possible to obtain a detailed image of the subject with high accuracy in a shorter time. In addition, since the configuration of the camera system 100 can be made to be relatively simple, the reliability of the entire camera system 100 can be improved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-198709, filed on Oct. 22, 2018, which is hereby incorporated by reference herein in its entirety.

What is claimed is:

1. A camera system, comprising:
a first camera fixed to a stage;
a second camera which is disposed on a support base of a panhead fixed to the stage in a state in which a direction of an optical axis of the second camera is adjustable and which has a narrower field angle than the first camera;
a storage unit in which a correlation between a positional coordinate in an image captured by the first camera and an angle of the support base for directing the optical axis in a direction corresponding to a respective position of the positional coordinate is stored in advance; and
a control unit,
wherein the control unit controls the angle of the support base based on the correlation such that the optical axis is directed to a position corresponding to a positional coordinate of a subject detected from an image captured by the first camera.

2. The camera system according to claim 1, wherein the controller obtains a distance from the camera system to the subject based on the positional coordinate of the subject detected from the image captured by the first camera, an amount of deviation between the subject and an image center in an image captured by the second camera, and an angle of the support base.

3. The camera system according to claim 1, wherein
the control unit,
after causing the optical axis to move to an angle corresponding to the positional coordinate of the subject detected from the image captured by the first camera, controls the panhead so that the subject is disposed at a center of an image captured by the second camera, and
obtains a distance from the camera system to the subject based on the positional coordinate of the subject detected from the image captured by the first camera and an angle of the support base when the subject is disposed at a center of an image captured by the second camera.

4. The camera system according to claim 1, wherein
the correlation is obtained according to a relationship between
positional coordinates, in an image in which a plurality of feature points at a known distance from the camera system are captured by the first camera, respectively corresponding to the plurality of feature points and
angles of the support base when the plurality of feature points are respectively disposed at a center of an image captured by the second camera.

5. The camera system according to claim 4, wherein
the correlation is obtained from the plurality of feature points which are disposed at a plurality distances, and
the control unit,
in a case where the subject is a known target object, obtains an approximated distance to the subject in accordance with the size of the subject in an image captured by the first camera,
and controls the angle of the support base based on the correlation according to the approximated distance.

6. The camera system according to claim 1, wherein the correlation is based on images of a grid-like chart pattern disposed at a known distance from the camera system that are captured respectively by the first camera and the second camera.

7. The camera system according to claim 1, wherein the second camera comprises a single focus lens.

8. A control method of a camera system that comprises
a first camera fixed to a stage;
a second camera which is disposed on a support base of a panhead fixed to the stage in a state in which a direction of an optical axis of the second camera is adjustable and which has a narrower field angle than the first camera; and
a storage unit in which a correlation between a positional coordinate in an image captured by the first camera and an angle of the support base for directing the optical axis in a direction corresponding to a respective position of the positional coordinate is stored in advance, the method comprising:
detecting a subject from an image captured by the first camera, and
controlling the angle of the support base based on the correlation such that the optical axis is directed to a position corresponding to a positional coordinate of a subject detected from an image captured by the first camera.

9. A non-transitory computer-readable storage medium storing a program for causing a computer to execute the control method of a camera system that comprises
a first camera fixed to a stage;
a second camera which is disposed on a support base of a panhead fixed to the stage in a state in which a direction of an optical axis of the second camera is adjustable and which has a narrower field angle than the first camera; and
a storage unit in which a correlation between a positional coordinate in an image captured by the first camera and an angle of the support base for directing the optical axis in a direction corresponding to a respective position of the positional coordinate is stored in advance, the method comprising:
detecting a subject from an image captured by the first camera, and
controlling the angle of the support base based on the correlation such that the optical axis is directed to a position corresponding to a positional coordinate of a subject detected from an image captured by the first camera.
